(19) United States
(12) Patent Application Publication
(10) Pub. No.: US 2015/0046941 A1
(43) Pub. Date: Feb. 12, 2015

(54) VIDEO DISPLAY DEVICE, VIDEO DISPLAY METHOD, AND PROGRAM

(71) Applicant: PANASONIC CORPORATION, Kadoma-shi, Osaka (JP)

(72) Inventor: Takumi Tanabe, Hyogo (JP)

(21) Appl. No.: 14/387,565

(22) PCT Filed: Aug. 29, 2012
(86) PCT No.: PCT/JP2012/005431

§ 371 Date: Sep. 24, 2014

(30) Foreign Application Priority Data
Mar. 28, 2012 (JP) 2012-074804

(51) Int. Cl. H04N 21/81; H04N 21/435

(52) U.S. Cl. CPC H04N 21/812; H04N 21/435
USPC 725/32

(57) ABSTRACT

An AV playback device includes: advertisement storage which stores an advertisement to be displayed on an AV monitor; a platform which displays an operation menu as a graphical user interface on the AV monitor; a platform which receives an operation on the operation menu on the screen by the user; and a advertisement player which displays the advertisement stored in the advertisement storage on the AV monitor upon the displaying of the operation menu on the AV monitor by the platform or the receiving of the operation by the platform.

### TECHNICAL FIELD

The present invention relates to a video display device, a video display method, and a program, and, in particular, to a technique for adaptive and flexible control of presentation of advertisements.

### BACKGROUND ART

There has been a known broadcast receiver which outputs a video signal for displaying an advertisement together with a graphical user interface (GUI) for operation of a device.

For example, Patent Literature (PTL) 1 discloses a broadcast receiver which receives, via broadcast signals, data of menus (for example, a volume menu) including advertisement data and stores the data in storage of the broadcast receiver. When a user performs an operation to have a menu displayed (for example, an operation of volume control), the broadcast receiver outputs a video signal for displaying a menu including an advertisement.

The data of a menu is assigned with version numbers. When receiving data of a new version, the broadcast receiver replaces advertisement data by updating data in storage with the new data.

In this configuration, the broadcast receiver causes an advertisement to be displayed not only as a commercial video between programs but also as an image upon a user operation on a device. Furthermore, advertisements can be replaced as needed, so that opportunities of advertising business are increased.

### CITATION LIST

### Patent Literature

[PTL 1]
Japanese Unexamined Patent Application Publication No. 2002-101360

### SUMMARY OF INVENTION

### Technical Problem

It is expected that the way of advertisement presentation will be widely used with a variety of video display devices. Thus, techniques for enhancing advertising effectiveness higher than ever before will be sought. Examples of such techniques include a technique for adaptive provision of advertisements to each video display device and a technique for flexible presentation of advertisements with variation and interestingness.

Conceived to address the situation, an object of the present invention is to provide a video display device, a video display method, and a program for adaptive and flexible control of advertisement presentation.

### Solution to Problem

In order to achieve the above-described object, a video display device according to an aspect of the present invention is provided. The video display device includes: storage which stores an advertisement to be displayed on a screen; an input unit configured to receive an operation performed by a user; a GUI control unit configured to display a graphical user interface (GUI) as an operation menu on the screen, when the GUI relates to the operation received by the input unit; and an advertisement playback unit configured to obtain an advertisement relating to the operation menu or the operation from the storage and display the advertisement on the screen upon the displaying of the operation menu by the GUI control unit or the receiving of the operation by the input unit.

### Advantageous Effects of Invention

The video display device according to the present invention is capable of playing an advertisement based on presentation mode information, and thereby achieves flexible presentation of advertisements with variation and interestingness. As a result, advertisements thus presented have effectiveness higher than ever before.

### BRIEF DESCRIPTION OF DRAWINGS

FIG. 1 is a functional block diagram illustrating an example of a configuration of an advertisement presentation system in an embodiment.

FIG. 2 shows an example of content of an advertisement storage in the embodiment.

FIG. 3 shows an example of content of an advertisement script in the embodiment.

FIG. 4 is a sequence diagram illustrating an example of advertisement display performed upon a user operation in the embodiment.

FIG. 5 is a flowchart illustrating a specific example of advertisement display in the embodiment.

FIG. 6A shows an example of an advertisement displayed upon a volume control operation in the embodiment.

FIG. 6B shows an example of an advertisement displayed upon a volume control operation in the embodiment.

FIG. 6C shows an example of an advertisement displayed upon a volume control operation in the embodiment.

FIG. 6D shows an example of an advertisement displayed upon a volume control operation in the embodiment.

FIG. 6E shows an example of an advertisement displayed upon a volume control operation in the embodiment.

FIG. 6F shows an example of an advertisement displayed upon a volume control operation in the embodiment.

FIG. 7 is a sequence diagram illustrating an example of download of an advertisement in the embodiment.

FIG. 8 shows an example of configuration information of a video display device in the embodiment.

### DESCRIPTION OF EMBODIMENTS

A video display device according to an aspect of the present invention includes: storage which stores an advertisement to be displayed on a screen; an input unit configured to receive an operation performed by a user; a GUI control unit configured to display a graphical user interface (GUI) as an operation menu on the screen, when the GUI relates to the operation received by the input unit; and an advertisement playback unit configured to obtain an advertisement relating to the operation menu or the operation from the storage and display the advertisement on the screen upon the displaying of the operation menu by the GUI control unit or the receiving of the operation by the input unit.

Furthermore, the storage may further store presentation mode information in which a mode of presentation of the advertisement is specified, and the advertisement playback unit may be configured to display the advertisement stored in the storage on the screen, according to the presentation mode information stored in the storage.

In this configuration, advertisements are flexibly presented with variation and interestingness. As a result, advertisements thus presented have effectiveness higher than ever before.

Furthermore, the advertisement playback unit may be configured to selectively perform or avoid, according to the presentation mode information stored in the storage, the displaying of the advertisement upon the displaying of the operation menu or the receiving of the operation.

In this configuration, advertisements are displayed to a user less frequently, so that the user will feel less annoyed with presentation of advertisements and be impressed at finding advertisements displayed less frequently than expected.

Furthermore, the advertisement playback unit may be configured to change, depending on a time segment or randomly according to the presentation mode information stored in the storage, a probability or a duration of displaying the advertisement upon the displaying of the operation menu or the receiving of the operation.

In this configuration, the mode of advertisement presentation is changed depending on a time segment or randomly. Advertisements are thereby presented to a user with variation, so that it is possible to avoid boring the user and deteriorating the effectiveness of the advertisements.

Furthermore, when displaying the advertisement upon the displaying of the operation menu or the receiving of the operation, the advertisement playback unit may be configured to display the advertisement at a position different from a position where the advertisement was once displayed.

In this configuration, an advertisement is displayed at a position different from a position where the advertisement was once displayed. Advertisements thus displayed draw attention of users, so that it is possible to avoid boring the user and deteriorating the effectiveness of the advertisements.

Furthermore, when displaying the advertisement upon the displaying of the operation menu or the receiving of the operation, the advertisement playback unit may be configured to display the advertisement at either a first position or a second position switchably therebetween on the screen, the first position and the second position each being associated with the operation menu.

In this configuration, an advertisement is displayed at a position out of at least two positions associated with an operation menu. Advertisements thus displayed draw attention of users, so that it is possible to avoid boring the user and deteriorating the effectiveness of the advertisements.

Furthermore, when displaying the advertisement upon the displaying of the operation menu or the receiving of the operation, the advertisement playback unit may be configured to display the advertisement next to the operation menu on the screen and gradate the advertisement in a part close to the operation menu.

In this configuration, the border between the advertisement and the operation menu is obscure. Such a way of presentation helps integration of the advertisement and the operation menu, and allows for preventing the part of the advertisement close to the operation menu from deteriorating viewability of the operation menu.

Furthermore, the GUI control unit may be configured to change a color of the operation menu in coordination with at least one of a color and content of the advertisement displayed by the advertisement playback unit.

In this configuration, the color of the operation menu is changed in coordination with at least one of the color and the content of the advertisement. Advertisements are thereby presented with further variation and interestingness, so that it is possible to avoid boring the user and deteriorating the effectiveness of the advertisements.

Furthermore, the GUI control unit may be further configured to make a change to a mode of presentation of the operation menu according to the operation performed by the user, and the advertisement playback unit may be configured to change the mode of presentation of the advertisement on the screen in response to the change in the mode of presentation of the operation menu.

Furthermore, the operation menu may be a slide bar for control of volume of sound output by the video display device, and the operation may be an instruction for shifting a slider of the slide bar.

In this configuration, the mode of presentation of the operation menu changes with the change in the mode of presentation of the operation menu. Advertisements are thereby presented with interestingness. As a result, advertisements thus presented have effectiveness higher than ever before.

Furthermore, the video display device may further include a download unit configured to preload an advertisement to be displayed by the advertisement playback unit from a server device connected to the video display device via a communication network, and store the advertisement in the storage.

In this configuration, advertisements to be displayed are preloaded, so that a delay in displaying an advertisement is shortened.

Furthermore, the advertisement playback unit may be configured to display the advertisement stored in the storage on the screen, when the input unit receives, as the operation, an operation for turning on the video display device.

In this configuration, it is possible to display an advertisement without a connection to the communication network immediately after the power is turned on.

Furthermore, the presentation mode information may include expiring time information indicating an end of a period in which the advertisement is displayed, and the advertisement playback unit may be configured to display the advertisement according to the expiration period information.

In this configuration, it is possible to avoid troubles which undermine the effectiveness of advertising, such as a lingering old advertisement.

Furthermore, the storage may further store an advertisement set as a default advertisement, and the advertisement playback unit may be configured to display the default advertisement stored in the storage, when the advertisement playback unit determines that the displaying of the operation menu or the receiving of the operation is later than the period indicated by the expiring time information.

In this configuration, it is possible to avoid a trouble that no advertisement is displayed because downloaded advertisements have already expired.

Furthermore, the presentation mode information may include time segment information indicating a time segment in which an advertisement is displayed, and the advertisement playback unit may be configured to display the advertisement according to the time segment information.

In this configuration, advertisement on the screen are changed depending on the time segment. Advertisements are thereby presented to a user with variation, so that it is possible to avoid boring the user and deteriorating the effectiveness of the advertisements.

These general and specific aspects may be implemented using a system, a method, an integrated circuit, a computer program, or a computer-readable recording medium, or any combination of systems, methods, integrated circuits, computer programs, or computer-readable recording media.

### Embodiment

The following describes a video display device according to an aspect of the present invention with reference to the drawings.

The embodiment is described as a specific example of the present invention. The values, materials, constituent elements, layout and connection of the constituent elements, steps, and the order of the steps in the embodiments are given not for limiting the present invention but merely for illustrative purposes only. Therefore, among the structural elements in the following exemplary embodiments, structural elements not recited in any one of the independent claims are described as arbitrary structural elements.

### (Advertisement Presentation System)

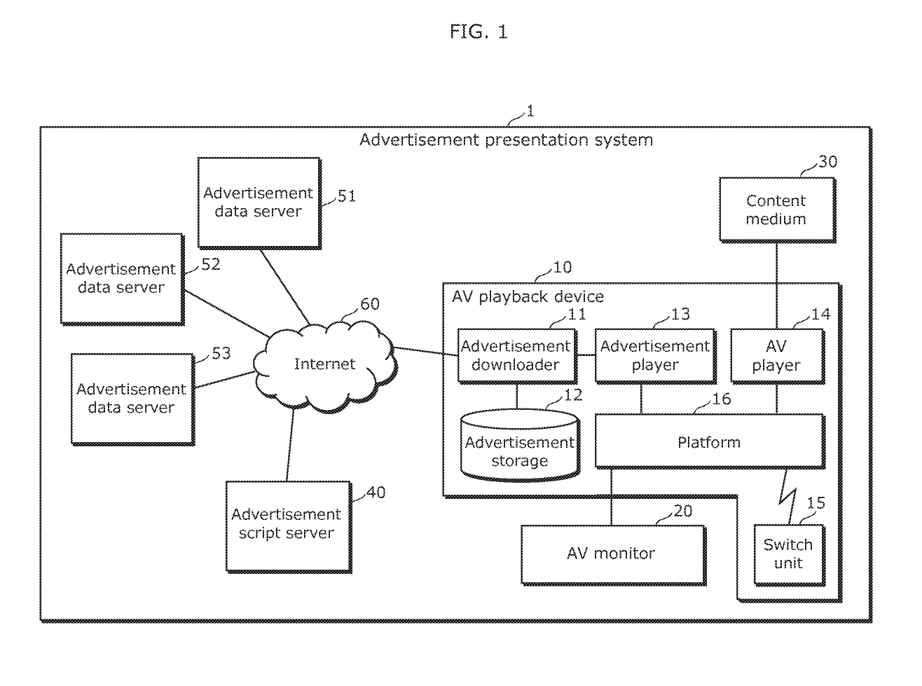

FIG. 1 is a functional block diagram illustrating an example of an advertisement presentation system according to the embodiment.

An advertisement presentation system 1 is a system which presents an advertisement in synchronization with a user operation performed on an audio and visual (AV) playback device 10, and includes an AV playback device 10, an AV monitor 20, a content medium 30, an advertisement script server 40, advertisement data servers 51 to 53, and the Internet 60.

The AV playback device 10 is an example of the video display device. The AV monitor 20 is an example of a screen. The advertisement data servers 50 to 53 are an example of server devices. The Internet 60 is an example of a communication network.

The AV playback device 10 plays AV content received from the content medium 30 by causing the AV monitor 20 to display images and output audio. The AV playback device 10 is also configured to cause the AV monitor 20 to display an advertisement in synchronization with a user operation performed on the AV playback device 10.

The AV monitor 20 is a device which displays images and outputs audio. Examples of constituent elements of the AV monitor 20 include a liquid-crystal display device, a plasma display device, an organic light-emitting diode display device, a video projector, and a loudspeaker. The AV monitor 20 may be integrated with the AV playback device 10 or may be provided separately. The AV monitor 20 may also be a display device capable of displaying 3D images using parallax.

The content medium 30 is a medium capable of containing AV content, and not limited to a specific type of medium. The content medium 30 may be any type of a medium capable of containing AV content. Examples of the medium include a broadcast channel, a communication line, a hard disk, an optical disc, and a semiconductor memory. Thus, the AV playback device 10 may be any consumer electronics (CE) which obtains and plays AV content from the content medium 30, such as a terrestrial television receiver, a satellite television receiver, a cable television receiver, an Internet television receiver, a hard disk video recorder-player, a digital versatile disc (DVD) player, a Blu-Ray disc player, or a digital media frame.

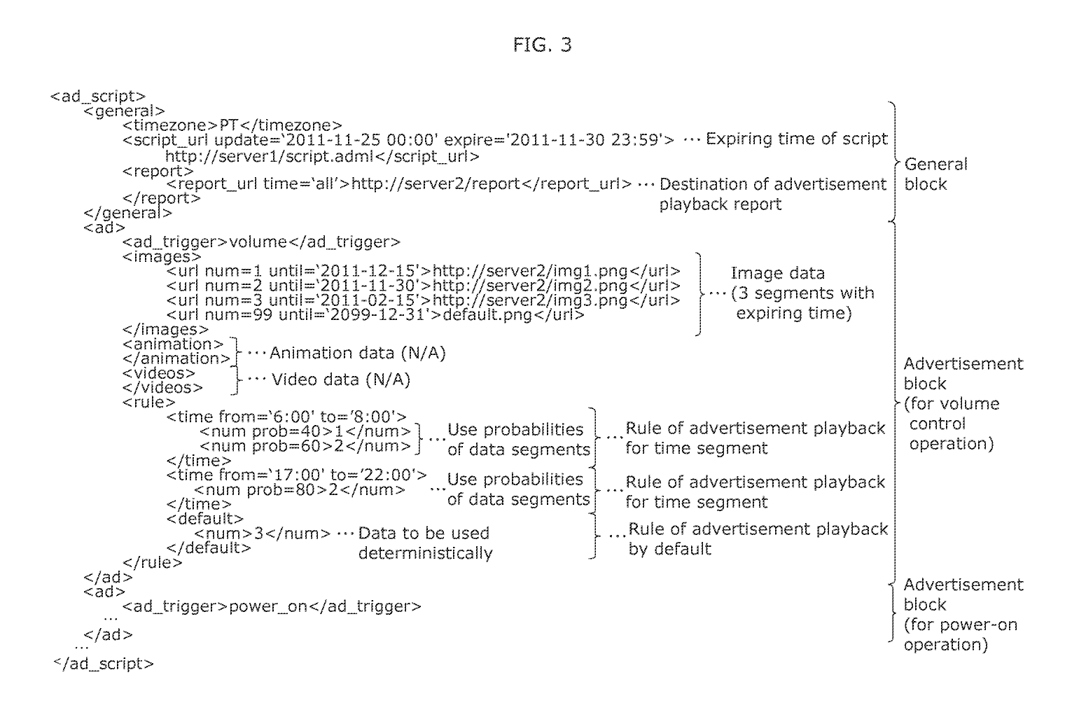

The advertisement script server 40 is a server connected to the Internet 60, and holds advertisement scripts in which a presentation mode of each advertisement is specified. The advertisement script is an example of presentation mode information. FIG. 3 shows an example of the advertisement script.

The advertisement data servers 51 to 53 are servers connected to the Internet 60, and store advertisement data of substantial content of advertisements, such as image, animations, and videos. Each of the advertisement data servers 51 to 53 may store advertisement data for a corresponding one of advertising companies.

The advertisement script stored in the advertisement script server 40 and the advertisement data stored in the advertisement data servers 51 to 53 are downloaded to the AV playback device 10 via the Internet 60. In response to a request from the AV playback device 10, the advertisement script server 40 includes addresses of the advertisement data servers 51 to 53 in an advertisement script as necessary so that the AV playback device 10 can obtain the advertisement data from the advertisement data servers 51 to 53.

The Internet 60 provides an interactive connection between the AV playback device 10, the advertisement script server 40, and the advertisement data servers 51 to 53.

### (AV Playback Device)

The following describes the AV playback device 10 in detail.

As shown in FIG. 1, the AV playback device 10 includes an advertisement downloader 11, advertisement storage 12, and an advertisement player 13, an AV player 14, a switch unit 15, and a platform 16.

The advertisement downloader 11 is a downloader for advertisement scripts and advertisement data. The advertisement downloader 11 downloads advertisement scripts from the advertisement script server 40 and advertisement data from the advertisement data servers 51 to 53 via the Internet 60, and stores the advertisement scripts and advertisement data in the advertisement storage 12. The advertisement downloader 11 may further include a network adapter for access to the Internet 60. The advertisement downloader 11 is an example of a download unit.

The advertisement storage 12 is a storage device which stores downloaded advertisement scripts and advertisement data. The advertisement storage 12 may include, for example, a hard disk drive or a semiconductor memory drive.

The advertisement player 13 is a renderer which interprets and executes an advertisement script and causes an advertisement to be displayed. The advertisement player 13 is activated from the platform 16 and decodes advertisement data of images, animations, videos, and the like and executes advertisement data codes according to the advertisement script. The advertisement player 13 decodes and executes advertisement data using a codec for images or videos and an interpreter for animations. Furthermore, the advertisement player 13 may decode and execute advertisement data using not only such a downloaded advertisement script but also a codec for images or videos and an interpreter for animations included in the platform 16. The advertisement player 13 is an example of an advertisement playback unit.

The AV player 14 is a decoder for AV content data. The AV player 14 obtains data of AV content from the content medium 30 and plays the AV content. The AV player 14 may have a configuration appropriate for the type of the content medium 30 from which AV content data is obtained. For example, the AV player 14 includes a television tuner, a network adapter, a hard disk drive, an optical disc drive, or a disk adapter. The AV player 14 may decode AV content data using an image codec and an audio codec included in the platform 16.

The switch unit 15 is an interface which receives user operations. For example, the switch unit 15 is an infrared remote control. The switch unit 15 receives user operations on the AV playback device 10, such as switching on and off the AV playback device 10 and turning up and down the volume of the AV playback device 10, and notifies the platform 16 of details of the operations. The switch unit 15 is an example of an input unit.

The platform 16 is a collective name for constituent elements for providing basic functions of the AV playback device 10. The platform 16 includes hardware elements, such as a central processing unit (CPU), a graphic processing unit (GPU), a random access memory (RAM), a read-only memory (ROM), and middleware elements, such as a controller for the entire AV playback device 10, image codecs, audio codecs, video codecs, and animation interpreters.

The platform 16 controls the entire AV playback device 10 according to user operations which the platform 16 is notified of by the switch unit 15.

When the switch unit 15 notifies the platform 16 of a user operation, the platform 16 instructs the advertisement player 13 to play an advertisement and generates a GUI appropriate for the type of the user operation (for example, when the user operation is an operation for adjusting the volume level, a slide bar for volume control is generated). Then, the platform 16 combines the advertisement played by the advertisement player 13 and the generated GUI. When the AV player 14 is playing AV content, the combined advertisement and the GUI are further combined with the AV content on a screen. The GUI is an example of an operation menu.

The platform 16 generates an AV signal which indicates the combined advertisement, GUI, and AV content item, and outputs the AV signal to the AV monitor 20. The platform 16 is an example of a GUI control unit.

The advertisement downloader 11, advertisement player 13, AV player 14, and the middleware included in the platform 16 may be provided as software functions achieved by the CPU executing a given program stored in the ROM or as hardware such as an integrated circuit. The middleware may be downloaded from an external server.

### (Advertisement Storage)

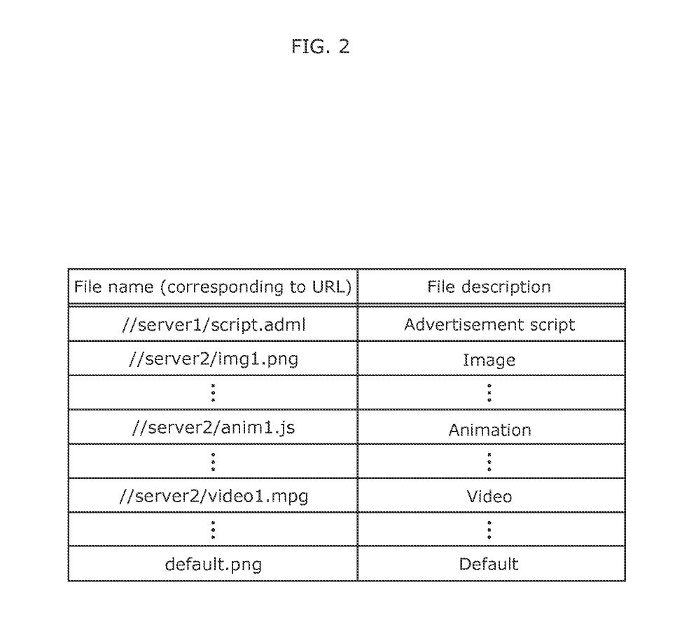

FIG. 2 shows an example of an advertisement script and advertisement data stored in the advertisement storage 12.

In the example shown in FIG. 2, the advertisement storage 12 stores a downloaded advertisement script and advertisement data segments as files each having a name corresponding to a uniform resource locator (URL) indicating an address on the Internet 60.

The advertisement script is a script in which URLs of advertisement data segments and rules of advertisement playback for each type of user operations are specified.

The advertisement data represents substantial advertisement content of an image, an animation, a video, or the like. Examples of the advertisement data include image data in a format such as Portable Network Graphics (PNG) or Joint Photographic Experts Group (JPEG), animation data described using JavaScript (registered trademark) (JS), Flash (SWF), or the like, and video data in a format such as Moving Picture Experts Group (MPEG) or QuickTime Movie (MOV). The advertisement data may include an advertisement data segment to be played by default.

### (Advertisement Script)

FIG. 3 shows an example of an advertisement script.

In the example shown in FIG. 3, the advertisement script includes a general block and one or more advertisement blocks each associated with a type of user operation.

The general block includes an expiring time of the advertisement script and a destination of an advertisement playback report.

Each of the advertisement blocks includes a type of user operation associated with the advertisement block, a URL of an advertisement data segment, and a rule of advertisement playback for each time segment. The rule of advertisement playback specifies an advertisement data segment to be played and a use probability of the advertisement data segment, for example.

The following describes part of the content of the advertisement script shown in FIG. 3.

The general block indicates that the advertisement script is valid until 23:59 on Nov. 30, 2011 and that an advertisement playback report is sent to http://server2/report.

In the advertisement block associated with a user operation for volume control, three image data segments at http://server2/img1.png, http://server2/img2.png, and http://server2/img3.png are designated. The advertisement block further includes an expiring time of each of the image data segments. Expired image data segments (for example, an advertisement data segment for a past limited-time offer) are no longer used. The advertisement block further includes rules of advertisement playback for time segments. The rules specify that the use probability of img1.png to img2.png are 40% to 60% from 6:00 to 8:00, the use probability of img2.png is 80% (that is, no advertisement is displayed at a probability of 20%) from 17:00 to 22:00, and img3.png is deterministically used by default in other time segments.

The subsequent advertisement block, which is associated with a user operation for power-on, includes similar content (details of the content is not described herein).

The following describes advertisement playback using the advertisement script and the advertisement data stored in the advertisement storage 12.

### (Advertisement Playback)

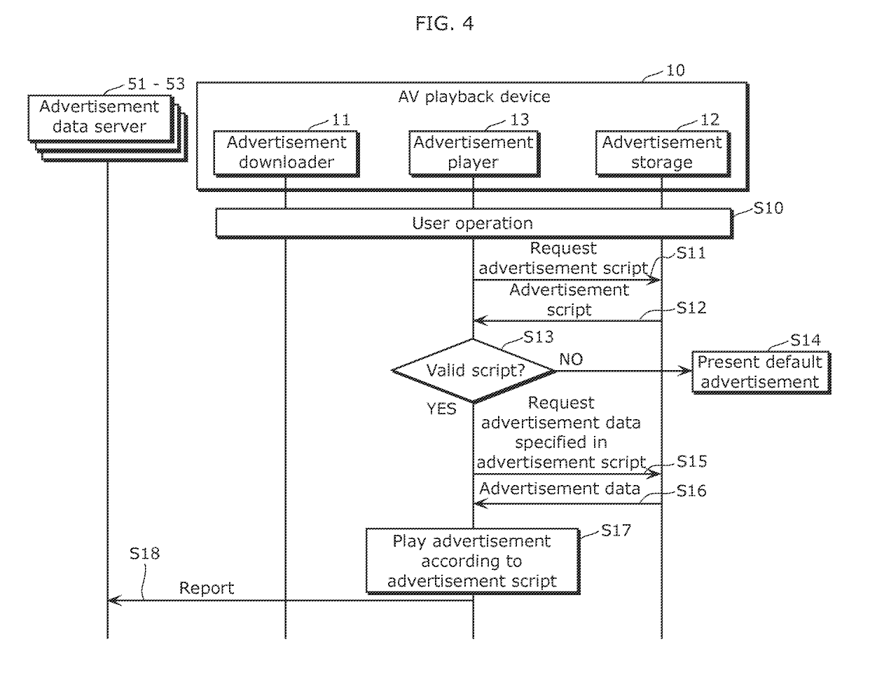

FIG. 4 is a sequence diagram illustrating an example of advertisement playback. The advertisement playback is performed only when the AV playback device 10 receives a user operation performed on the AV playback device 10 by a user.

When receiving a user operation (S10), the platform 16 gives the advertisement player 13 an instruction to play an advertisement corresponding to the user operation. Upon receiving the instruction to play an advertisement, the advertisement player 13 retrieves an advertisement script from the advertisement storage 12 (S11, S12). The advertisement player 13 need not retrieve the same advertisement script again when the advertisement player 13 has already retrieved the advertisement script.

The advertisement player 13 determines whether or not the advertisement script is valid (S13). When the advertisement script is not valid (S13, NO), the advertisement player 13 plays a default content item (S14). The advertisement player 13 determines whether or not the advertisement script is valid by comparison between the expiring time specified in the general block of the advertisement script and the current time on the AV playback device 10.

When the advertisement script is valid (S13, YES), the advertisement player 13 retrieves, from the advertisement storage 12, an advertisement data segment specified in an advertisement block corresponding to the present user operation (S15, S16), and plays an advertisement according to rules of advertisement playback included in the advertisement block (S17). After finishing the advertisement playback, the advertisement player 13 sends an advertisement playback report to an advertisement data server among the advertisement data servers 51 to 53 from which the advertisement player 13 has downloaded the advertisement data segment used for the advertisement playback (S18).

### (Details of Processing for Advertisement Playback)

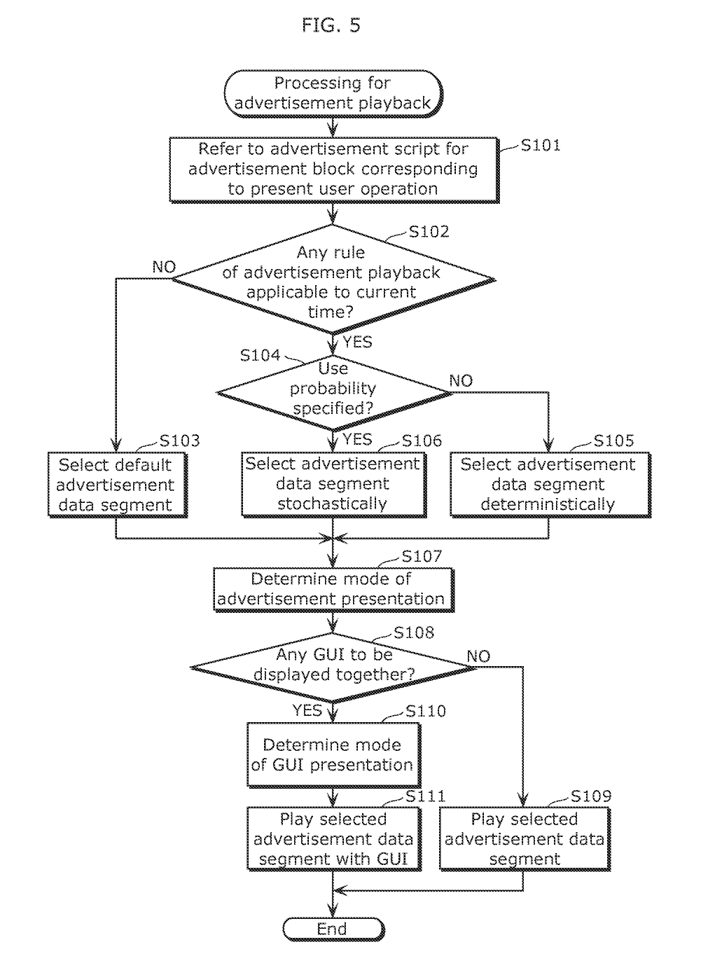

FIG. 5 is a flowchart illustrating a detailed example of processing for advertisement playback performed by the advertisement player 13.

The advertisement player 13 refers to an advertisement script for an advertisement block corresponding to the type of a present user operation (S101). When the advertisement block includes no rule of advertisement playback for a time segment applicable to the current time (S102, NO), the advertisement player 13 selects an advertisement data segment specified in a default rule of advertisement playback (S103).

When the advertisement block includes a rule of advertisement playback for a time segment including the current time (S102, YES), the advertisement player 13 performs the following processing.

First, the advertisement player 13 selects an advertisement data segment to be used. When the advertisement block includes a use probability of an advertisement data segment (S104, YES), the advertisement player 13 selects the advertisement data segment stochastically according to the use probability included in the advertisement block (S106). When the total of use probabilities included in the rules of advertisement playback for the current time segment is smaller than 100, the advertisement player 13 may select no advertisement data segment, and thus no advertisement is displayed. When the advertisement block includes no use probability of an advertisement data segment (S104, NO), the advertisement player 13 selects an advertisement data segment deterministically (S106).

The advertisement player 13 may select an advertisement data segment using additional information other than the time segment. For example, when each AV content item and each advertisement data segment are previously provided with category information, the advertisement player 13 may select, according to the category information, an advertisement data segment relating to an AV content item currently being played or played most recently. The category information may be provided to each scene in an AV content item. In this case, a relating advertisement data segment is selected for each scene in the AV content item.

After selecting an advertisement data segment, the advertisement player 13 then determines a mode of advertisement presentation (S107). The mode of advertisement presentation determines, for example, a position, color, size, and display duration of the advertisement. The mode of advertisement presentation may be represented by an advertisement data segment itself or additionally described in an advertisement script as shown in FIG. 3 (the additional description is not shown in the drawings).

The advertisement player 13 may determine, as the mode of advertisement presentation, a mode of advertisement presentation represented by an advertisement data segment itself or a mode of advertisement presentation described in an advertisement script. The advertisement player 13 may computationally determine a mode of advertisement presentation using an embedded program each time the advertisement player 13 selects an advertisement data segment.

The advertisement player 13 may position advertisement images at a fixed position, such as in a lower left corner of a screen. Alternatively, the advertisement player 13 may position advertisements images at different positions. For example, an advertisement image is positioned in one of four corners of a screen, and then the next advertisement image is positioned in another one of the four corners. Alternatively, the advertisement player 13 may position an advertisement image at a position selected from positions each associated with a GUI. Furthermore, the advertisement player 13 may switch positions of a GUI and an advertisement image each time a new advertisement image is displayed.

The advertisement player 13 may determine colors of an advertisement images as specified in advertisement data. Alternatively, the advertisement player 13 may determine a color different from a color specified in advertisement data of an advertisement image as a color of the advertisement image in coordination with colors of a GUI displayed together with the advertisement image or colors of images of an AV content item on a screen.

The advertisement player 13 may determine the size of advertisement images as specified in advertisement data. Alternatively, the advertisement player 13 may change the size of an advertisement image in coordination with change in the mode of GUI presentation. For example, an advertisement image is displayed in a larger size when a slider of a volume bar indicates a higher volume level. Furthermore, an advertisement image may be displayed over an area where a volume bar indicates the volume level.

The advertisement player 13 may set the display duration of an advertisement at a fixed length, such as 3 seconds. Alternatively, the advertisement player 13 may change the display duration of an advertisement randomly within a range, such as a range of 2 to 10 seconds.

Next, when there is no applicable GUI to be displayed to the type of a current user operation (S108, NO), for example, when the device is turned on, the advertisement player 13 plays the selected advertisement data segment in the determined mode (S112).

When there is an applicable GUI to be displayed to the type of a current user operation (S108, YES), for example, when the volume level is changed, the advertisement player 13 determines a mode of GUI presentation (S110). The mode of GUI presentation determines, for example, a position, color, size, and appearance of the GUI.

The advertisement player 13 may position a GUI at a fixed position, such as in a lower right corner of a screen. Alternatively, the advertisement player 13 may switch positions of a GUI and an advertisement image each time a new advertisement image is displayed.

The color of a GUI may be fixed. Alternatively, the color of a GUI may be changed in coordination with colors of an advertisement image displayed together.

A GUI may have an appearance such that the GUI itself serves as an advertisement.

Next, the advertisement player 13 plays the selected advertisement data segment and the GUI in the respective determined modes (S111).

### (Examples of the Mode of Advertisement Presentation)

The following describes examples of the mode of advertisement presentation on the AV monitor 20 by the AV playback device 10 with the above-described configuration. In the following examples, it is assumed that a user watching a weather report on television performs an operation to change the volume level.

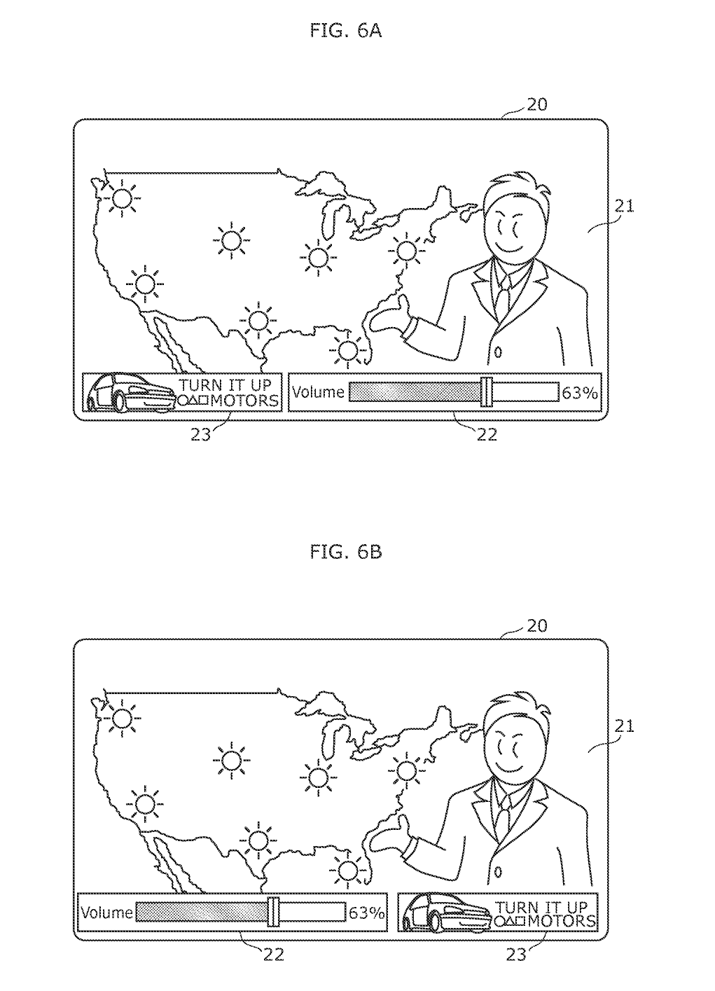

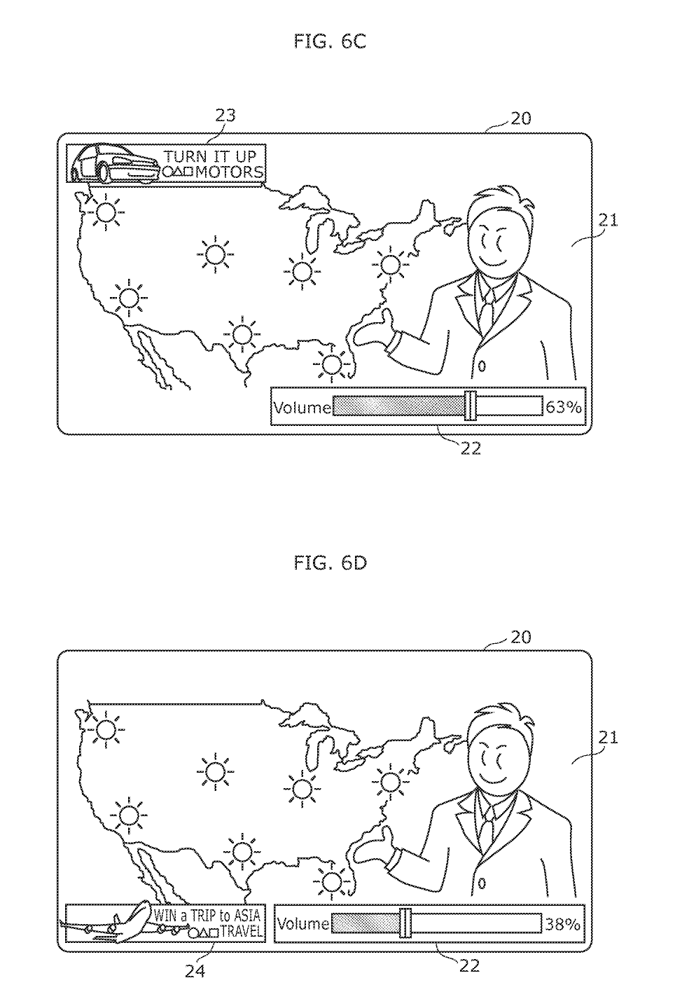

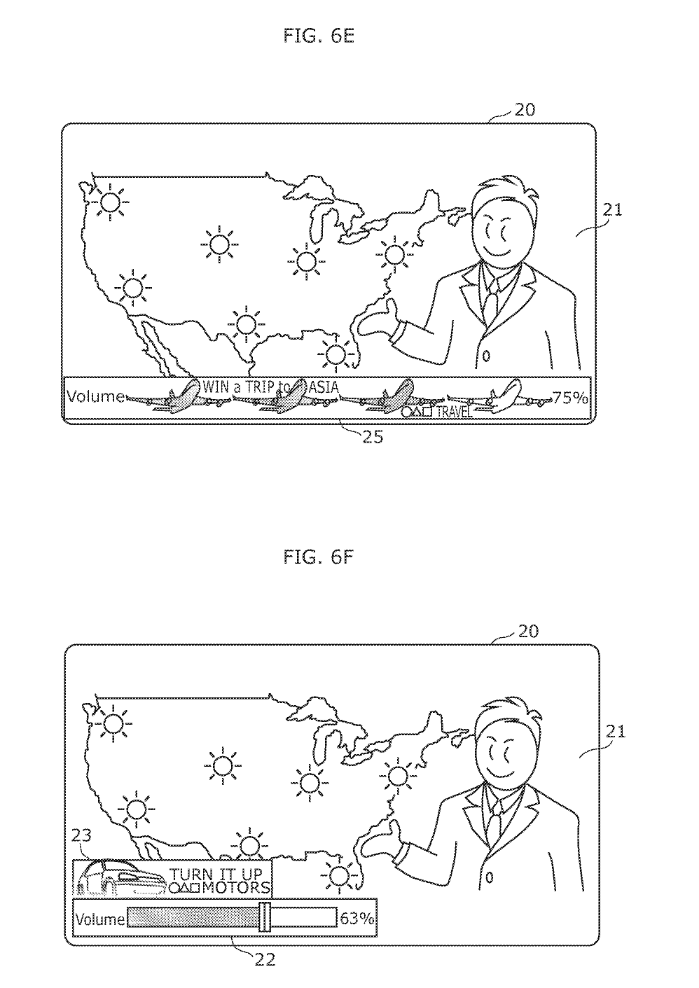

FIG. 6A shows an example of the mode of advertisement presentation. In this example, when a user watching a television picture 21 on a television presses a volume button of a switch unit 15 (infrared remote control), the television shows a slide bar 22 at the bottom right of the screen of the television and at the same time an advertisement image 23 at the bottom left.

FIG. 6B shows an example where, in contrast to FIG. 6A, the position of the advertisement image 23 and the position of the slide bar 22 are switched. The presentation shown in FIG. 6A and the presentation shown in FIG. 6B are selectively performed so that the screen may switchably display a picture in which the advertisement image 23 is shown at a first position (bottom-left) corresponding to the slide bar 22 displayed at the bottom right position and a picture in which the advertisement image 23 is shown at a second position (bottom-right) corresponding to the slide bar 22 displayed at the bottom left position.

FIG. 6C shows an example where the position of the advertisement image 23 is different from the position of the advertisement image 23 shown in FIG. 6A. The presentation shown in FIG. 6A and the presentation shown in FIG. 6C are selectively performed so that the position of the advertisement 23 may be changed from a position where the advertisement 23 was once displayed (bottom-left) to another position (top-left).

FIG. 6D shows an example where an advertisement image 24 different from the advertisement image 23 shown in FIG. 6A is displayed. Such changing of advertisement images may be performed depending on a time segment or in coordination with an AV content item or a scene in the AV content item currently on the screen. For example, an advertisement of a travel company as shown in FIG. 6D is displayed as an advertisement relating to travel when a user watching a travel program performs an operation to change the volume level or when a user turns on the AV playback device 10 on the morning after the day the user watches a travel program.

FIG. 6E shows an example of the mode of advertisement presentation in which a GUI has an appearance such that the GUI itself serves as an advertisement. In the example of the mode of advertisement presentation, an appearance of the advertisement image 24 is applied to a slide bar 25.

FIG. 6F shows an example of the mode of advertisement presentation in which the advertisement 23 and the slide bar 25 are displayed next to each other, and the colors of the advertisement 23 are gradated in the part close to the slide bar 25. The gradating of the advertisement 23 may be performed either in the AV playback device 10 or by any of the advertisement data servers 51 to 53 before sending the image data of the advertisement 23.

In the example shown in FIG. 6, the advertisement 23 is displayed next to the slide bar 25 thereabove, and the lower part of the advertisement 23 is gradated. In the gradated part, the transparency of the advertisement 23 is gradually changed from 0% to 100% so that the advertisement 23 fades out in the part. The positions of the advertisement 23 and the slide bar 25 may be switched. In this case, the advertisement 23 is faded out toward the slide bar 25 in its upper part.

Alternatively, the advertisement 23 and the slide bar 25 may partially overlap each other. In this case, the image of the advertisement 23 and the slide bar 25 may be blended to transition gradually from one to the other in the part where they are overlapping.

When the advertisement 23 is gradated in the part close to the slide bar 25, the border between the advertisement 23 and the slide bar 25 is obscure. Such a way of presentation helps integration of the advertisement 23 and the slide bar 25, and allows for preventing the part of the advertisement 23 close to the slide bar 25 from deteriorating viewability of the slide bar 25. This way of presentation produces the same advantageous effect also when the advertisement 23 and the slide bar 25 are laterally or diagonally next to each other.

When any of the advertisement data servers 51 to 53 gradates an advertisement image before sending, the AV playback device 10 displays the slide bar 25 along the gradated part of the advertisement image. In this case, the advertisement data servers 51 to 53 may include, in an advertisement script to send, information on arrangement of the advertisement image and the slide bar 25 or information on the gradated part (for example, position of the gradated part, transparency of the gradated part). Alternatively, the advertisement data servers 51 to 53 and the AV playback device 10 shares information on a predetermined arrangement of an advertisement image and the slide bar 25. The advertisement data servers 51 to 53 which gradate an advertisement image allows for smaller load of the AV playback device 10 and gradation of advertisement images without deteriorating advertising effectiveness.

In another example, the size of an advertisement image may be increased as a user turns up the volume higher (not shown in the drawings). In yet another example, the size of an advertisement image may be increased as a user turns down the volume lower. In yet another example, the size of an advertisement image may be increased be more eye-catching while the audio is muted because the user is probably not watching the video content on a screen. Alternatively, an advertisement image may not be displayed while a GUI is displayed.

The advertisement image may be an animation. For example, the advertisement image 23 may be an animation of a car with spinning wheels, and the advertisement image 24 may be an animation of an airplane taking off and flying away. In another example, an advertisement image may be displayed without being accompanied by a GUI, and the advertisement image is shifted further to the right on a screen as the volume is turned up higher, and further to the left as the volume is turned down lower. In this manner, an advertisement image itself may be an animation. Furthermore, the position of an advertisement image may be freely moved as an animation on a screen.

Furthermore, when an advertisement image is displayed in response to an operation which is neither performed to cause a GUI to appear on a screen nor performed on an AV content item currently on a screen, such as an operation to turn on a device, the advertisement image may be displayed over the screen.

### (Advertisement Download)

The following describes advertisement download in which an advertisement script and advertisement data are downloaded and stored in the advertisement storage 12.

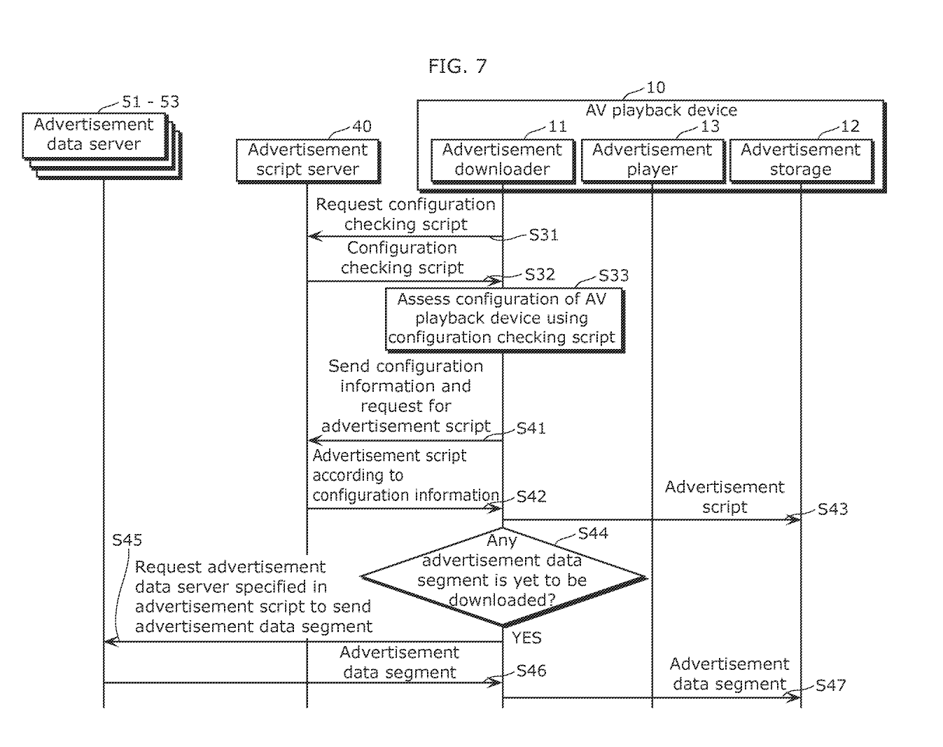

FIG. 7 is a sequence diagram illustrating an example of advertisement download. The advertisement download is performed as needed while the AV playback device 10 is connected to the Internet 60.

For example, the advertisement downloader 11 starts advertisement download on a scheduled date and time or at a predetermined interval, with reference to the current date and time on the AV playback device 10.

The advertisement downloader 11 downloads a configuration checking script from the advertisement script server 40 before downloading an advertisement script (S31, S32). The configuration checking script is an example of a program for assessing presentation capability of the AV playback device 10. The configuration checking script is, for example, a script for obtainment of configuration information of the AV playback device 10 in relation to capability for advertisement presentation. The advertisement downloader 11 obtains configuration information of the AV playback device 10 in relation to capability for advertisement presentation by executing the configuration checking script (S33).

The advertisement downloader 11 provides the advertisement script server 40 with the obtained configuration information (S41). The advertisement script server 40 transmits an advertisement script appropriate for the provided configuration information to the advertisement downloader 11 (S42). The advertisement downloader 11 receives an advertisement script from the advertisement script server 40, and stores the advertisement script in the advertisement storage 12 (S43).

When the advertisement script includes a description as to an advertisement data segment not stored in the advertisement storage 12 (S44, YES), the advertisement downloader 11 downloads the advertisement data segment according to a URL specified in the advertisement script (S45, S46), and stores the advertisement data in the advertisement storage 12 (S47).

### (Configuration Information of AV Playback Device)

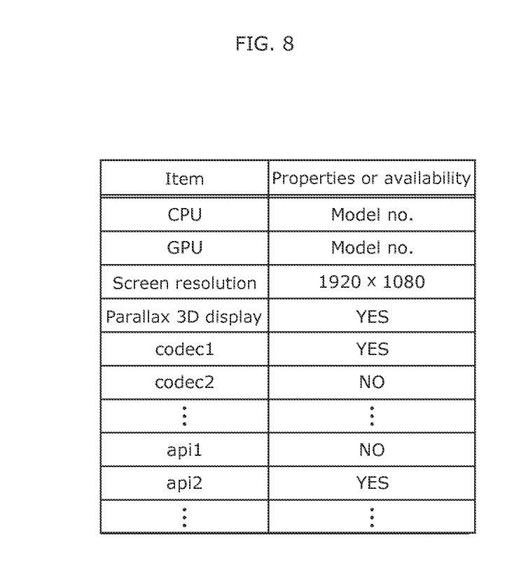

FIG. 8 shows an example of the configuration information of the AV playback device 10 obtained by executing the configuration checking script.

Referring to FIG. 8, the example of the configuration information in relation to capability for advertisement presentation of the AV playback device 10 includes items indicating hardware specifications, such as the model number of a central processing unit (CPU), the model number of a graphics processing unit (GPU), screen resolution, capability for parallax 3D display, available codecs, and available application interface (API).

Some of the items in FIG. 8 may be dependent on each other, so that capability for advertisement presentation of the AV playback device 10 may be sufficiently indicated by part of the items in FIG. 8.

Based on such configuration information provided to the advertisement script server 40 by the advertisement downloader 11, the advertisement script server 40 selects, from among prepared advertisement scripts, an advertisement script indicating only an advertisement data segment which the AV playback device 10 is capable of playing appropriately, and provides the selected advertisement script to the AV playback device 10.

Optionally, the advertisement script server 40 may generate an advertisement script appropriate for the AV playback device 10. For example, the advertisement script server 40 may select a script for an animation already stored in the advertisement script server 40 and generate a script by combining the selected script and a script instructing obtainment of a picture or a video from the advertisement data server 51, 52, or 53, and transmit the generated script to the AV playback device 10.

It is therefore easy to change content of an advertisement on the screen while applying the same animation effect to the advertisement.

For example, the advertisement script server 40 may generate an advertisement script appropriate for the AV playback device 10 based on device information of the AV playback device 10 so that an advertisement data server which provides data of an advertisement related to a peripheral device suitable for the AV playback device 10 is selected.

Optionally, an advertisement data server may be selected depending on current time.

More specifically, an advertisement for a predetermined manufacturer may be selectively displayed or restricted. For example, advertisements for alcoholic drinks are restricted in a time segment in children may view such advertisements.

The downloading of a configuration checking script and obtaining of a configuration information (S31 to S33 in FIG. 7) need not be performed each time an advertisement script is downloaded. They may be performed less frequently than the downloading of an advertisement script. In this case, the obtained configuration information may be stored in the advertisement storage 12, and the advertisement script server 40 may be provided with the configuration information stored in the advertisement storage 12.

### (Conclusion)

The AV playback device 10 and the advertisement presentation system 1 produce various advantageous effects as follows.

An advertisement is played using an advertisement data segment and a mode which are specified in each advertisement script. It is therefore possible to present a variety of advertisements as intended by a provider of the advertisement script through a very simple operation of replacing one advertisement script with another.

An effective period is set for each advertisement script and each advertisement data segment. This enables preloading of an advertisement script and an advertisement data segment in order to shorten a delay in displaying an advertisement, and allows for avoidance of troubles which undermine the effectiveness of advertising, such as a lingering old advertisement. Preloading an advertisement script and an advertisement data segment also produces an advantageous effect that an advertisement is displayed without a connection to the Internet, particularly immediately after the power is turned on, for example.

The mode of advertisement presentation, such as position, color, size, display duration, use probability, is flexibly controlled according to description in advertisement scripts. Advertisements are thereby presented to a user with variation and interestingness, so that it is possible to avoid boring the user and deteriorating the effectiveness of the advertisements.

The mode of advertisement presentation is changed depending on the type of user operation or the time segment. It is also possible to set a probability at which an advertisement is NOT presented. It is therefore possible to adjust frequency of displaying an advertisement during a prime-time slot or in response to a type of user operations frequently performed, such as an operation for volume control. This will make a user impressed and allow the user to feel less annoyed with appearance of advertisements on the screen.

The mode of GUI presentation, such as the position, color, appearance of a GUI is changeable in coordination with the mode of advertisement presentation. For example, the color of a slide bar is changed in coordination with the color of an advertisement, so that advertisements can be presented with increased variation and interestingness. It is thereby possible to avoid boring the user and deteriorating effectiveness of the advertisements. Furthermore, the effectiveness of advertisements may be enhanced by changing the mode of GUI presentation in coordination with the content of the advertisement. For example, the color of a slide bar may be changed in coordination with the corporate color of the advertiser.

Each AV playback device provides the advertisement script server with configuration information as to its own capability for advertisement presentation. This allows the advertisement script server to selectively provide the AV playback device with an advertisement script with which the AV playback device can appropriately play advertisement data.

For example, when configuration information indicates that the AV playback device 10 is capable of presenting parallax 3D images, the AV playback device 10 is provided with an advertisement script in which image data for parallax 3D presentation is specified as advertisement data. When configuration information indicates that the AV playback device 10 is not capable of presenting parallax 3D images, the AV playback device 10 is provided with an advertisement script in which image data for normal 2D presentation is specified as advertisement data.

As a result, the AV playback device need not make a complicated determination for download of appropriate advertisement data and provides appropriate advertising effectiveness by performing advertisement playback according to a downloaded advertisement script selected by the advertisement script server.

In particular, some consumer electronics AV playback devices support only limited types of advertisement data for the purpose of optimization of cost for platform, for example. When this is the case, if each AV playback device is required to select, from among advertisement data segments stored in many advertisement data servers, an advertisement data segment to download which the AV playback device itself supports, this operation of the AV playback device is troublesome. Such troublesomeness is all eliminated by the advertisement script server which selectively provides each AV playback device with an advertisement script in accordance with configuration information of the AV playback device.

In order to download an advertisement script, the AV playback device need not communicate with other than the advertisement script server which centrally manages advertisement scripts. Then, the AV playback device interprets the downloaded advertisement script and communicates with an advertisement data server, so that the AV playback device may play an advertisement as appropriate.

As described above, the AV playback device 10 and the advertisement presentation system 1 are provided as a video display device and an advertisement presentation system which are capable of adaptive and flexible control of advertisement presentation.

### INDUSTRIAL APPLICABILITY

The present invention is applicable to a variety of systems which display advertisements on consumer electronics.

### REFERENCE SIGNS LIST

1 Advertisement presentation system
10 AV playback device
11 Advertisement downloader
12 Advertisement storage
13 Advertisement player
14 AV player
15 Switch unit
16 Platform
20 AV monitor
21 Television image
22, 25 Slide bar
23, 24 Advertisement
30 Content medium
40 Advertisement script server
51 to 53 Advertisement data server
60 Internet

1. A video display device comprising:
storage which stores an advertisement to be displayed on a screen;
an input unit configured to receive an operation performed by a user;
a GUI control unit configured to display a graphical user interface (GUI) as an operation menu on the screen, when the GUI relates to the operation received by the input unit; and
an advertisement playback unit configured to obtain an advertisement relating to the operation menu or the operation from the storage and display the advertisement on the screen upon the displaying of the operation menu by the GUI control unit or the receiving of the operation by the input unit.

2. The video display device according to claim 1,
wherein the storage further stores presentation mode information in which a mode of presentation of the advertisement is specified, and
the advertisement playback unit is configured to display the advertisement stored in the storage on the screen, according to the presentation mode information stored in the storage.

3. The video display device according to claim 2,
wherein the advertisement playback unit is configured to selectively perform or avoid, according to the presentation mode information stored in the storage, the displaying of the advertisement upon the displaying of the operation menu or the receiving of the operation.

4. The video display device according to claim 2,
wherein the advertisement playback unit is configured to change, depending on a time segment or randomly according to the presentation mode information stored in the storage, a probability or a duration of displaying the advertisement upon the displaying of the operation menu or the receiving of the operation.

5. The video display device according to claim 1,
wherein when displaying the advertisement upon the displaying of the operation menu or the receiving of the operation, the advertisement playback unit is configured to display the advertisement at a position different from a position where the advertisement was once displayed.

6. The video display device according to claim 5,
wherein when displaying the advertisement upon the displaying of the operation menu or the receiving of the operation, the advertisement playback unit is configured to display the advertisement at either a first position or a second position switchably therebetween on the screen, the first position and the second position each being associated with the operation menu.

7. The video display device according to claim 1,
wherein when displaying the advertisement upon the displaying of the operation menu or the receiving of the operation, the advertisement playback unit is configured to display the advertisement next to the operation menu on the screen and gradate the advertisement in a part close to the operation menu.

8. The video display device according to claim 1,
wherein the GUI control unit is configured to change a color of the operation menu in coordination with at least one of a color and content of the advertisement displayed by the advertisement playback unit.

9. The video display device according to claim 1,
wherein the GUI control unit is further configured to make a change to a mode of presentation of the operation menu according to the operation performed by the user, and
the advertisement playback unit is configured to change the mode of presentation of the advertisement on the screen in response to the change in the mode of presentation of the operation menu.

10. The video display device according to claim 1,
wherein the operation menu is a slide bar for control of volume of sound output by the video display device, and
the operation is an instruction for shifting a slider of the slide bar.

11. The video display device according to claim 1, further comprising
a download unit configured to preload an advertisement to be displayed by the advertisement playback unit from a server device connected to the video display device via a communication network, and store the advertisement in the storage.

12. The video display device according to claim 1,
wherein the advertisement playback unit is configured to display the advertisement stored in the storage on the screen, when the input unit receives, as the operation, an operation for turning on the video display device.

13. The video display device according to claim 2,
wherein the presentation mode information includes expiring time information indicating an end of a period in which the advertisement is displayed, and
the advertisement playback unit is configured to display the advertisement according to the expiration period information.

14. The video display device according to claim 13,
wherein the storage further stores an advertisement set as a default advertisement, and
the advertisement playback unit is configured to display the default advertisement stored in the storage, when the advertisement playback unit determines that the displaying of the operation menu or the receiving of the operation is later than the period indicated by the expiring time information.

15. The video display device according to claim 2,
wherein the presentation mode information includes time segment information indicating a time segment in which an advertisement is displayed, and
the advertisement playback unit is configured to display the advertisement according to the time segment information.

16. A video display method comprising:
storing an advertisement to be displayed on a screen;
receiving an operation performed by a user;
when a graphical user interface (GUI) relates to the operation received by the input unit, displaying the GUI as an operation menu on the screen; and
when the operation menu is displayed in the displaying of the GUI, obtaining an advertisement relating to the operation menu or the operation from the storage, and displaying the advertisement on the screen upon the displaying of the operation menu or the receiving of the operation.

17. A non-transitory computer-readable recording medium on which a program which causes a computer to execute the video display method according to claim 16 is recorded.

18. A video display device comprising:
a screen;
storage which stores an advertisement to be displayed on the screen; and
an advertisement playback unit configured to display the advertisement stored in the storage on the screen, when the video display device is turned on,
wherein the advertisement includes expiring time information indicating an end of a period in which the advertisement is displayed, and
the advertisement playback unit is configured to display the advertisement only before the end of the period.
